(19) United States
(12) Patent Application Publication
(10) Pub. No.: US 2026/0365158 A1
(43) Pub. Date: Nov. 19, 2026

(54) MOISTURE AND PARTICLE MANAGEMENT

(71) Applicant: INTERNATIONAL BUSINESS MACHINES CORPORATION, Armonk, NY (US)

(72) Inventors: Michael Boone, Lutz, FL (US); Irving A. Duran, Dubuque, IA (US); Sarbajit Kumar Rakshit, Kolkata (IN); Jacob Ryan Jepperson, Inver Grove Heights, MN (US)

(21) Appl. No.: 19/209,360

(22) Filed: May 15, 2025

(51) Int. Cl. B60W 30/06; B60H 1/00; B60W 10/30; B60W 60/00

(52) U.S. Cl. CPC B60W 30/06; B60H 1/00785; B60W 10/30; B60W 60/001; B60W 2400/00; B60W 2555/20; B60W 2710/30

(57) ABSTRACT

A method for moisture condition and particle condition management of components on a vehicle includes determining, utilizing one or more sensors on a vehicle, a first moisture level for a first zone of the vehicle. The method also includes identifying a first weather condition to address the first moisture level for the first zone of the vehicle. The method also includes performing, by one or more systems on the vehicle, a first action based on the first moisture level for the first zone of the vehicle and the first weather condition, where the first action includes relocating the vehicle to a parking area with the first weather condition.

### BACKGROUND

This disclosure relates generally to moisture and particle management, and in particular to moisture condition and particle condition management for components on a vehicle.

Vehicles presently utilize various hardware and componentry that is sensitive to environmental conditions. The hardware on a vehicle can include sensors, radars, and modules that are positioned on an exterior or interior of the vehicle. The componentry can include structural and aesthetic items that are positioned on the exterior or the interior of the vehicle. Though most of the various hardware and componentry on a vehicle are isolated from the environment and manufactured to a specification to withstand the environmental conditions, long term exposure can affect a lifespan and reliability of the hardware and componentry.

### SUMMARY

Embodiments in accordance with the present invention disclose a method, computer program product and computer system for moisture condition and particle condition management of components on a vehicle, the method, computer program product and computer system can determine, utilizing one or more sensors on a vehicle, a first moisture level for a first zone of the vehicle. The method, computer program product and computer system identify a first weather condition to address the first moisture level for the first zone of the vehicle. The method, computer program product and computer system perform, by one or more systems on the vehicle, a first action based on the first moisture level for the first zone of the vehicle and the first weather condition, wherein the first action includes relocating the vehicle to a parking area with the first weather condition.

### BRIEF DESCRIPTION OF THE SEVERAL VIEWS OF THE DRAWINGS

FIG. 1 is a functional block diagram illustrating a computing environment, in accordance with an embodiment of the present invention.

FIG. 2 depicts a flowchart of a moisture and particle management program for determining a prioritization plan to address moisture conditions and particle conditions on a vehicle, in accordance with an embodiment of the present invention.

FIG. 3 depicts a flowchart of a moisture and particle management program for managing moisture conditions and particle conditions on a vehicle utilizing a prioritization plan, in accordance with an embodiment of the present invention.

FIG. 4 depicts an example of vehicle for which a moisture and particle management program addresses moisture conditions and particle conditions, in accordance with an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments. It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

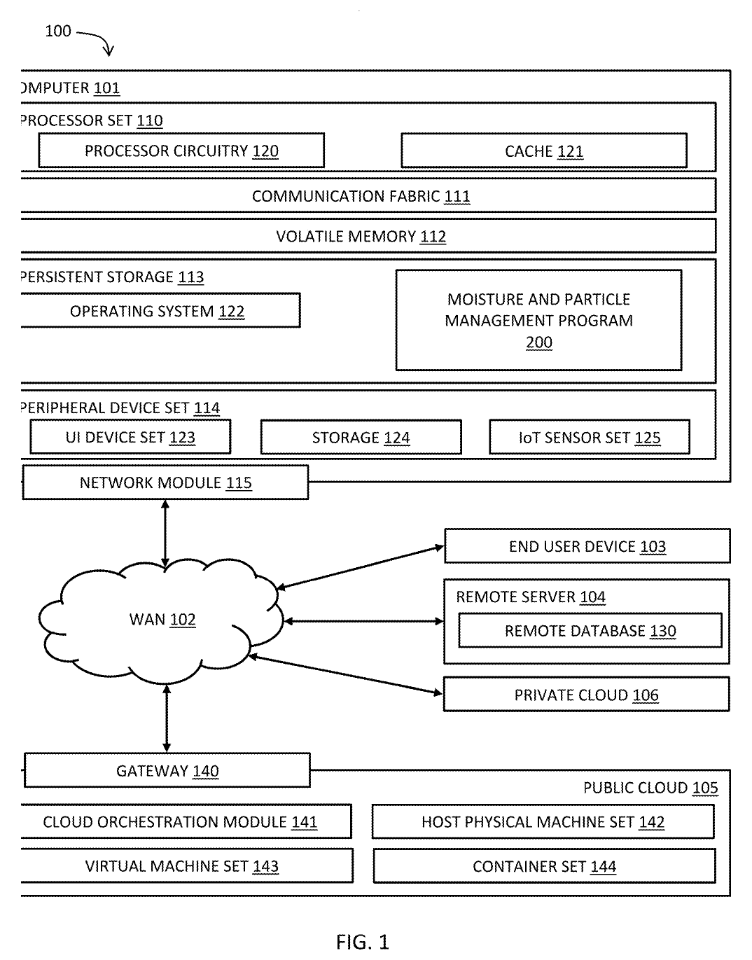

FIG. 1 is a functional block diagram illustrating a computing environment, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 100 contains an example of an environment for the execution of at least some of the computer code involved in performing the inventive methods, such as moisture and particle management program 200. In addition to moisture and particle management program 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and moisture and particle management program 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in moisture and particle management program 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in moisture and particle management program 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

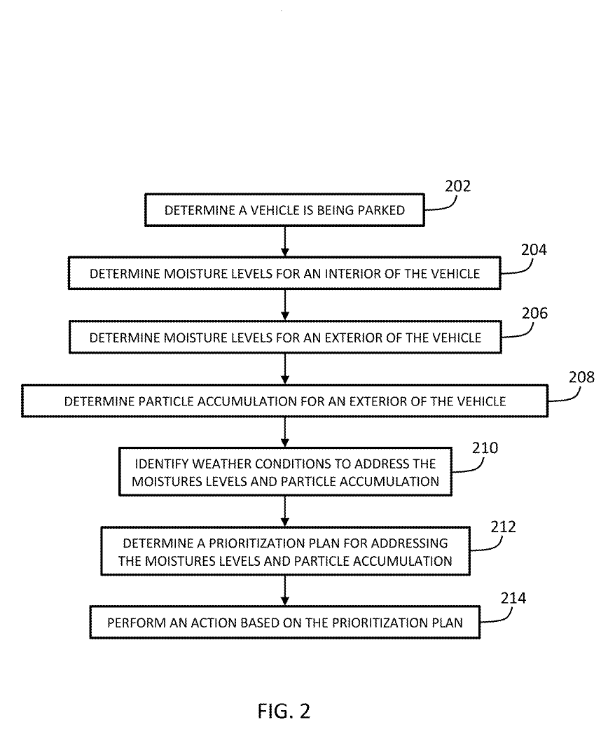

FIG. 2 depicts a flowchart of a moisture and particle management program for determining a prioritization plan to address moisture conditions and particle conditions on a vehicle, in accordance with an embodiment of the present invention.

Moisture and particle management program 200 determines a vehicle is being parked (202). For discussion purposes, the vehicle can have autonomous or semi-autonomous driving capabilities that allow for the vehicle to operate in an autonomous or semi-autonomous manner. In one embodiment, moisture and particle management program 200 determines the vehicle is being parked based on a Global Positioning System (GPS) location of the vehicle, where moisture and particle management program 200 identifies the vehicle as being located at a known parking area (e.g., parking lot, parking structure) utilizing available mapping software. In another embodiment, moisture and particle management program 200 determines the vehicle is being parked based on one or more sensors activating due to a proximity threshold being reached between the vehicle and an object (e.g., another vehicle). In yet another embodiment, moisture and particle management program 200 determines a vehicle is being parked based on a user input activating one or more parking based features on the vehicle.

Moisture and particle management program 200 determines moisture levels for an interior of the vehicle (204). Moisture and particle management program 200 utilizes one or more sensors positioned in an interior of the vehicle to determine a moisture level or moisture levels for the interior of the vehicle. The one or more sensors can include temperature and/or humidity measuring sensors capable of providing temperature and humidity level readings for different portions of the interior of the vehicle. Moisture and particle management program 200 can divide an interior volume of the vehicle into multiple zones, where a subset of sensors determine moisture levels for each of the multiple zones of the interior volumes of the vehicle. In some embodiments, moisture and particle management program 200 utilizes existing temperature and humidity measuring sensors that are part of the climate control system for the vehicle. A vehicle can include one or more climate zones for which the climate control system manages based on user settings. Moisture and particle management program 200 utilizes the existing sensors that are part of the climate control system by querying the climate control system and receiving the humidity and temperature levels for each of the sensors. In some embodiments, moisture and particle management program 200 utilizes one or more temperature and/or humidity sensors integrated into one or more hardware components (e.g., electronic control unit, modules) to determine moisture levels for the interior of the vehicle. In some embodiments, moisture and particle management program 200 utilizes one or more dedicated temperature and/or humidity sensors positioned within the vehicle to determine moisture levels for the interior of the vehicle.

Moisture and particle management program 200 determines moisture levels for an exterior of the vehicle (206). Moisture and particle management program 200 utilizes one or more sensors positioned on an exterior surface of the vehicle to determine a second moisture level or moisture levels for various portions of the vehicle. The one or more sensors can include temperature and/or humidity measuring sensors capable of providing temperature and humidity level readings for the various portions of the exterior of the vehicle. Moisture and particle management program 200 can divide an exterior surface of the vehicle into multiple zones (i.e., sub-areas), where a subset of sensors determines moisture levels for each of the multiple zones of the exterior surface of the vehicle. In some embodiments, moisture and particle management program 200 utilizes one or more temperature and/or humidity sensors integrated into one or more hardware components (e.g., electronic control unit, modules) to determine moisture levels for the exterior surface of the vehicle. In some embodiments, moisture and particle management program 200 utilizes one or more dedicated temperature and/or humidity sensors positioned on an exterior surface of the vehicle to determine moisture levels.

Moisture and particle management program 200 determines particle accumulation for an exterior of the vehicle (208). Moisture and particle management program 200 utilizes one or more sensors and cameras positioned on the vehicle to determine particle accumulation for the exterior surface of the vehicle. The one or more sensors can include ultrasonic sensors and Light Detection and Ranging (LIDAR) modules associated with various safety systems, assisted driving systems, and autonomous driving systems. The one or more cameras can include cameras capturing a surrounding area of the vehicle, along with cameras capturing an interior of the vehicle. For the one or more sensors, moisture and particle management program 200 can determine if a sensor is generating a reading indicating an obstruction of the sensor due to particle accumulation. Particle accumulation can include dirt, ice, snow, and biomaterial that impedes operations of the one or more sensors and cameras. In one example, an ultrasonic proximity sensor, often referred to as a parking sensor, can produce readings (e.g., fluctuating values) indicating a possible obstruction of the ultrasonic proximity sensor. As a result, moisture and particle management program 200 determines there is particle accumulation in a zone on the exterior of the vehicle surrounding the ultrasonic sensor producing the readings indicating the possible obstructions. In another example, a camera located behind a windshield of a vehicle can capture ice accumulation. As a result, moisture and particle management program 200 determines there is particle accumulation (i.e., ice accumulation) in a zone on the exterior of the vehicle surrounding the windshield.

Moisture and particle management program 200 identifies weather conditions to address the moisture levels and particle accumulation (210). Based on the determined moisture levels for the interior and exterior of the vehicle and the particle accumulation for the exterior of the vehicle, moisture and particle management program 200 identifies weather conditions to address the moisture levels and particle accumulation. For elevated moisture levels (e.g., high humidity), moisture and particle management program 200 identifies sun exposure as a weather condition to address the elevated moisture levels by raising a temperature to lower the humidity (i.e., evaporate the moisture). For low moisture levels (e.g., low humidity) and high temperatures, moisture and particle management program 200 identifies shade cover as a weather condition to address the low moisture levels and high temperature levels by lowering the temperature of the vehicle. For particle accumulation such as dust and/or organic material, moisture and particle management program 200 identifies precipitation (e.g., rain) as a weather condition to address the particle accumulation to wash away the dust and/or organic material. For particle accumulation such as ice and/or snow, moisture and particle management program 200 identifies sun exposure as a weather condition to address the particle accumulation to accelerate melting of the ice and/or snow.

Moisture and particle management program 200 determines a prioritization plan for addressing the moisture levels and particle accumulation (212). A prioritization plan is a list of one or more actions performable by a vehicle and/or driver, where the vehicle can operate in a semi-autonomous vehicle and/or an autonomous vehicle. Moisture and particle management program 200 determines the prioritization plan based on a ranking of the moisture levels and particle accumulation to be addressed, the identified weather conditions for addressing the moisture levels and particle accumulation, current weather conditions, predicated weather conditions, time, and/or a location of the vehicle. In some embodiments, prior to determining the prioritization plan, moisture and particle management program 200 determines the ranking of the moisture levels and the particles accumulation to be addressed based on a safety criteria and/or a damage criteria.

Moisture and particle management program 200 utilizes the safety criteria to rank the moisture level and particle accumulation items from high safety risk to low safety risk, where high safety risk ranked items are prioritized when determining the prioritization plan. Any item of moisture level or particle accumulation that can affect operations of the vehicle is prioritized over any item of moisture level or particle accumulation that does not affect operations of the vehicle. In one example, if moisture and particle management program 200 identifies particle accumulation in the form of ice captured by a camera on the vehicle, moisture and particle management program 200 ranks the particle accumulation as a high safety risk and prioritizes this item to be addressed in the prioritization plan. In another example, if moisture and particle management program 200 identifies particle accumulation in the form of organic material captured by a camera on the vehicle, moisture and particle management program 200 ranks the particle accumulation as a low safety risk and prioritization for this item is set lower in the prioritization plan.

Moisture and particle management program 200 utilizes the damage criteria to rank the moisture level and particle accumulation items from high risk of damage to low risk of damage, where high risk of damage ranked items are prioritized when determining the prioritization plan. An item of moisture level or particle accumulation that can rapidly wear (e.g., corrosion due to moisture) a component on the vehicle is prioritized over any item of moisture level or particle accumulation that can slowly wear (e.g., dust accumulation) a component on the vehicle. In one example, if moisture and particle management program 200 identifies a moisture level in a first zone of an interior of a vehicle as being elevated (e.g., humidity level greater than 80%), moisture and particle management program 200 ranks the moisture level in a first zone of the interior of the vehicle as a high risk of damage and prioritizes the item to be addressed in the prioritization plan. In another example, if moisture and particle management program 200 identifies particle accumulation in the form of ice captured by a camera on the vehicle, moisture and particle management program 200 ranks the particle accumulation as a low risk of damage to the vehicle and prioritization for this item is set lower in the prioritization plan.

Moisture and particle management program 200 utilizes current and/or predicated weather conditions when determining the prioritization plan for addressing the moisture levels and particle accumulation. If current weather conditions favor addressing a first item over a second time when compared to predicated weather conditions which are to occur at a later time (e.g., 6 hours), moisture and particle management program 200 prioritizes the first item over the second item. Therefore, moisture and particle management program 200 addresses the first item under the current weather conditions and addresses the second item under the predicated weather conditions. Moisture and particle management program 200 can receive current and/or predicated weather conditions from one or more sensors on the vehicle and/or a third party service that provides weather conditions and forecasting.

Moisture and particle management program 200 utilizes time and a location of the vehicle when determining the prioritization plan for addressing the moisture levels and particle accumulation, since the location dictates an exposure to the identified weather conditions for addressing the moisture levels and particle accumulation. In one example, moisture and particle management program 200 determines a vehicle is being parked in a parking structure with limited direct sunlight, where direct sunlight is available on a limited amount of parking spots in the parking structure throughout the day. Moisture and particle management program 200 can prioritize the items with previously identified weather conditions requiring sunlight to address the moisture levels and/or particle accumulation. In another example, moisture and particle management program 200 determines a vehicle is being parked in a parking lot with limited direct sunlight due to surrounding buildings blocking direct sunlight to the parking lot in a first half of the day. However, moisture and particle management program 200 determines that during a second half of the day the parking lot receives direct sunlight. Moisture and particle management program 200 can prioritize the items with previously identified weather conditions that do not require sunlight to address the moisture levels and/or particle accumulation. Once direct sunlight is available at a later point in time (e.g., second half of the day), moisture and particle management program 200 can prioritize the items with previously identified weather conditions requiring sunlight to address the moisture levels and/or particle accumulation.

Moisture and particle management program 200 performs an action based on the prioritization plan (214). As previously discussed, the prioritization plan ranks items of moisture levels and particle accumulation to be addressed for the vehicle. Moisture and particle management program 200 performs an action based on the highest ranked item on the prioritization plan, wherein the action is performable by the vehicle. In one example, moisture and particle management program 200 performs an action of displaying a recommendation to a driver of the vehicle to address an item on the prioritization plan. The recommendation can include instructing the driver to relocate the vehicle to a parking spot that has direct sunlight to address ice buildup located on an exterior of the vehicle (i.e., particle accumulation). In another example, moisture and particle management program 200 performs an action by altering a setting one or more systems of the vehicle to address an item from the prioritization plan. Altering one or more systems can include but is not limited to activating a climate control system of the vehicle (e.g., powering on a fan motor), altering a setting on a climate control system (e.g. powering on air conditioning compressor), activating a washer fluid motor, activating an electric motor for the window (i.e., opening or closing a window), activating an electric motor for a window shade, and activating an electromagnetic window. In yet another example, moisture and particle management program 200 performs an action by relocating the vehicle from a first location to a second location to address an item from the prioritization plan. For a vehicle with semi-autonomous and/or autonomous driving capabilities, moisture and particle management program 200 activates one or more systems (e.g., drive motors, LIDAR, cameras) to relocate the vehicle from the first location (e.g., shaded area) to the second location (non-shaded area) to address the item (e.g., snow buildup) from the prioritization plan.

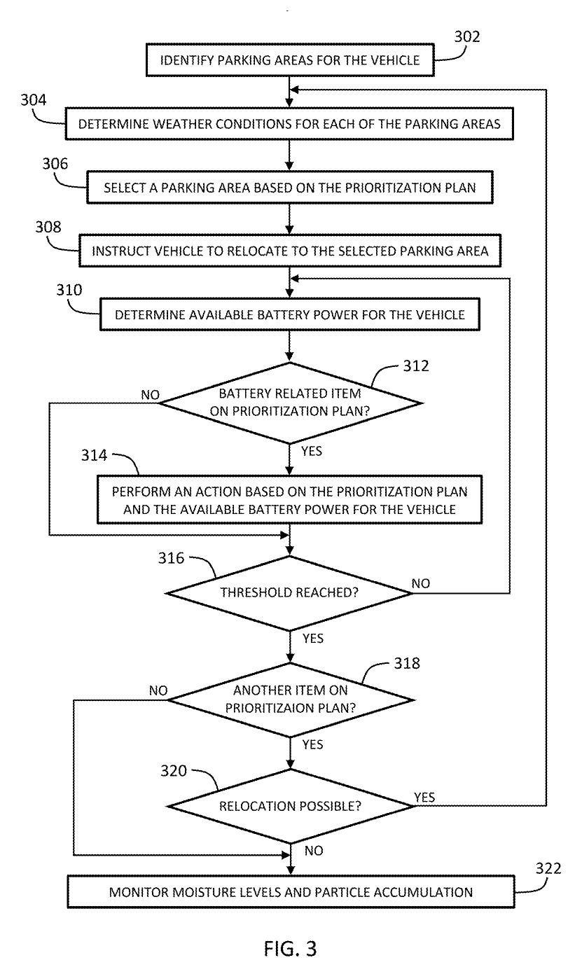

FIG. 3 depicts a flowchart of a moisture and particle management program for managing moisture conditions and particle conditions on a vehicle utilizing a prioritization plan, in accordance with an embodiment of the present invention.

Moisture and particle management program 200 identifies parking areas for the vehicle (302). As vehicle entering a parking area, such as a parking lot or parking structure, moisture and particle management program 200 identifies available parking spots or bays into which the vehicle can park. Moisture and particle management program 200 identifies parking area utilizes one or more systems on the vehicle including but not limited to parking sensors, cameras, and LIDAR.

Moisture and particle management program 200 determines weather conditions for each of the parking areas (304). Subsequent to identifying the parking areas for the vehicle, moisture and particle management program 200 determines current weather conditions for each of the identified parking areas. Moisture and particle management program 200 determines the current weather conditions for each of the parking areas utilizing cameras on the vehicle, temperature sensors on the vehicle, rain sensors on the vehicle, and/or current weather forecast information from a third party service provider. In one example, moisture and particle management program 200 identifies three parking areas for the vehicle and determines, utilizing a camera on the vehicle, that a first parking and a second parking area are shaded, and a third parking area is non-shaded. In another example, moisture and particle management program 200 identifies two parking area for the vehicle and determines, utilizing a camera and a rain sensor on the vehicle, that a first parking area is covered on a lower level of a parking structure and a second parking area is not covered on an upper level of the parking structure, based on the rain sensor detecting precipitation near the second parking area.

Moisture and particle management program 200 selects a parking area based on the prioritization plan (306). As previously discussed with respect to FIG. 2, moisture and particle management program 200 determines the prioritization plan for addressing the moisture levels and particle accumulation on the vehicle. Based on the highest ranked item on the prioritization plan, moisture and particle management program 200 selects the parking area from the identified parking area with the determined weather condition that can address the highest ranked item on the prioritization plan. In one example, moisture and particle management program 200 previously determined snow on the exterior of the vehicle (i.e., particle accumulation) is the highest ranked item on the prioritization plan due to a safety criteria. Moisture and particle management program 200 identifies three parking areas for the vehicle and determines that a first parking and a second parking area are shaded, and a third parking area is non-shaded. Moisture and particle management program 200 selects the third parking area from the identified three parking areas to address the highest ranked item on the prioritization plan. In another example, moisture and particle management program 200 determines organic material on the exterior of the vehicle (i.e., particle accumulation) is the next ranked item on the prioritization plan that can be addressed. Moisture and particle management program 200 identifies two parking area for the vehicle and determines that a first parking area is covered on a lower level of a parking structure and a second parking area is not covered on an upper level of the parking structure, based on the rain sensor detecting precipitation near the second parking area. Moisture and particle management program 200 selects the second parking area since the detected precipitation near the second parking can address the next ranked item on the prioritization plan.

Moisture and particle management program 200 instructs vehicle to relocate to the selected parking area (308). In one example, moisture and particle management program 200 displaying a recommendation to a driver of the vehicle to address an item on the prioritization plan. The recommendation includes instructing the driver to relocate the vehicle to the selected parking area that has direct sunlight to address snow accumulation located on an exterior of the vehicle (i.e., particle accumulation). In another example, moisture and particle management program 200 instructs one or more systems on the vehicle to relocating to the selected parking area. For a vehicle with semi-autonomous and/or autonomous driving capabilities, moisture and particle management program 200 activates one or more systems (e.g., drive motors, LIDAR, cameras) to relocate the vehicle to the selected parking area to address the item (e.g., snow accumulation) from the prioritization plan.

Moisture and particle management program 200 determines available battery power for the vehicle (310). For an internal combustion engine vehicle, moisture and particle management program 200 determines available battery power for the 12-volt battery system on the internal combustion engine vehicle. For an electric or hybrid vehicle, moisture and particle management program 200 determines available battery power for both the 12-volt battery system and propulsion battery system (e.g., 48-volt, 800-volt) on the electric or hybrid vehicle. Moisture and particle management program 200 utilizes the available battery power to identify which of the one or more systems on the vehicle can be activated to address one or more items in the prioritization plan.

Moisture and particle management program 200 determines whether a battery related item is on the prioritization plan (decision 312). A battery related item on the prioritization plan represents a moisture level and/or a particle accumulation item that can be addressed by one or more systems on the vehicle. In one example, if moisture and particle management program 200 determines an elevated moisture level for the interior of the vehicle is on the prioritization plan, moisture and particle management program 200 determines the elevated moisture level for the interior of the vehicle is a battery related item since a climate control system on the vehicle can operate utilizing available battery power to address the elevated moisture level. In another vehicle, if moisture and particle management program 200 determines a particle accumulation of snow on the exterior of the vehicle is on the prioritization plan, moisture and particle management program 200 determines the particle accumulation of snow is a battery related item since the electric vehicle can utilize the available battery power to relocate to another parking area that is non-shaded to address the particle accumulation of snow.

In the event moisture and particle management program 200 determines a battery related item is on the prioritization plan (“yes” branch, decision 312), moisture and particle management program 200 performs an action based on the prioritization plan and the available battery power for the vehicle (314). In the event moisture and particle management program 200 determines a battery related item is not on the prioritization plan (“no” branch, decision 312), moisture and particle management program 200 determines whether a threshold is reached (decision 316).

Moisture and particle management program 200 performs an action based on the prioritization plan and the available battery power for the vehicle (314). Moisture and particle management program 200 performs the action for an item on the prioritization plan activating one or more systems and/or or one or more components operating on the available battery power. Moisture and particle management program 200 utilizes available battery power limits to ensure that available battery power does not fall below a threshold, such as, a 40% state of charge (SoC). In the example where moisture and particle management program 200 determines the elevated moisture level for the interior of the vehicle is a battery related item, moisture and particle management program 200 performs an action by activating a climate control system and an associated air conditioning compressor on the vehicle to lower the elevated moisture level for the interior of the vehicle and address the item on the prioritization plan. In the example where moisture and particle management program 200 determines the particle accumulation of snow is a battery related item, moisture and particle management program 200 performs an action by activating one or more systems to relocate the vehicle to a parking area that is non-shaded to address the item on the prioritization plan.

Moisture and particle management program 200 determines whether a threshold is reached (decision 316). In one embodiment, moisture and particle management program 200 utilizes available battery power limits to ensure that available battery power does not fall below a threshold, such as, a 40% state of charge (SoC). In another embodiment, moisture and particle management program 200 determines updated moisture levels and/or particle accumulation for the vehicle to determine if a threshold is reached. If an updated moisture level falls below a particular value (e.g., 70% humidity level), moisture and particle management program 200 determines the threshold has been reached for the item on the prioritization plan. If an updated particle accumulation indicated there is no longer any particular accumulation (e.g., ice), Moisture and particle management program 200 determines the threshold has been reached for the item on the prioritization plan.

In the event moisture and particle management program 200 determines a threshold is reached (“yes” branch, decision 316), moisture and particle management program 200 determines whether another item is on the prioritization plan (decision 318). In the event moisture and particle management program 200 determines a threshold is not reached (“yes” branch, decision 316), moisture and particle management program 200 reverts and determines available battery power for the vehicle (310).

Moisture and particle management program 200 determines whether another item is on the prioritization plan (decision 318). In the event moisture and particle management program 200 determines another item is on the prioritization plan (“yes” branch, decision 318), moisture and particle management program 200 determines whether relocation of the vehicle is possible (decision 320). In the event moisture and particle management program 200 determines another item is not on the prioritization plan (“no” branch, decision 318), moisture and particle management program 200 monitors moisture levels and particle accumulation (322).

Moisture and particle management program 200 determines whether relocation of the vehicle is possible (decision 320). In the event moisture and particle management program 200 determines relocation of the vehicle is not possible (“no” branch, decision 320), moisture and particle management program 200 monitors moisture levels and particle accumulation (322). In the event moisture and particle management program 200 determines relocation of the vehicle is possible (“yes” branch, decision 320), moisture and particle management program 200 reverts determines weather conditions for each of the parking areas (304).

Moisture and particle management program 200 monitors moisture levels and particle accumulation (322). Similar to how moisture and particle management program 200 determines moisture levels for an interior and exterior of a vehicle, and particular accumulation for an exterior of the vehicle in FIG. 2, moisture and particle management program 200 continues to monitor the moisture levels and particle accumulations for the vehicle. If moisture and particle management program 200 identifies a new moisture level and/or particle accumulation that needs to be addressed, moisture and particle management program 200 can update the prioritization plan based on the new moisture level and/or particle accumulation that needs to be addressed.

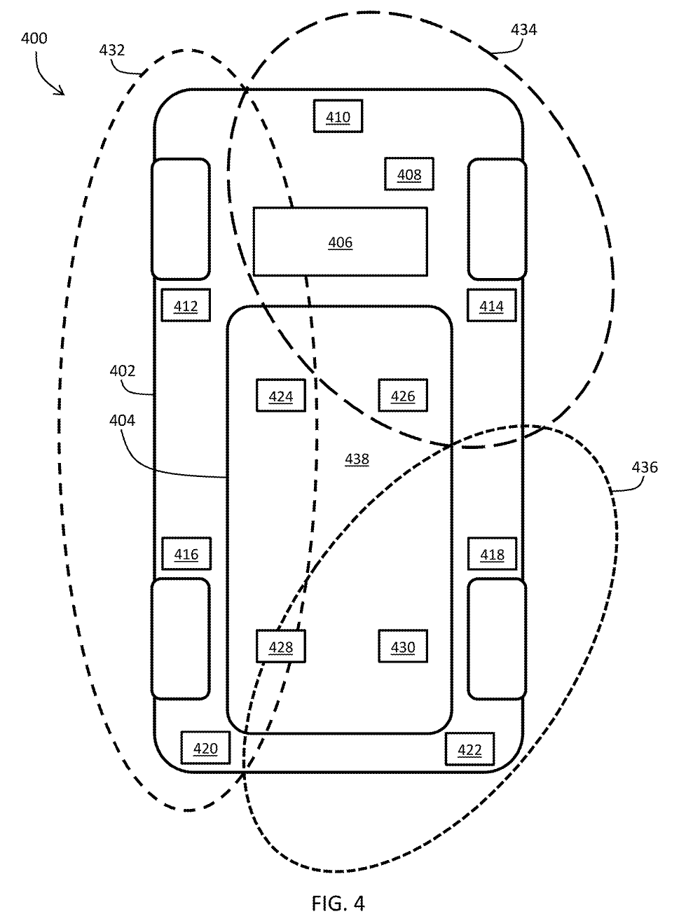

FIG. 4 depicts an example of vehicle for which a moisture and particle management program addresses moisture conditions and particle conditions, in accordance with an embodiment of the present invention. In this example, vehicle 400 includes exterior portion 402 and interior portion 404. Vehicle 400 includes devices 406, 408, 410, 412, 414, 416, 418, 420, and 422 positioned in various locations on exterior portion 402. Vehicle 400 also includes devices 424, 426, 428, and 430 positioned in various locations in interior portion 404 of vehicle 400. Devices 406 – 430 represent various sensors and cameras that allow for moisture and particle management program 200 to determine moisture levels for exterior portion 402 and interior portion 404, along with particle accumulation for exterior portion 402 of vehicle 400.

Moisture and particle management program 200 determines vehicle 400 is being parked and determined moisture levels for interior portion 404 of vehicle utilizing devices 424 – 430 and exterior portion 402 of vehicle 400 utilizing devices 406 – 422. Moisture and particle management program 200 also determines particle accumulation on exterior portion 402 of vehicle 400 utilizing device 406 – 422. Moisture and particle management program 200 determines weather conditions to address the moisture levels and particle accumulation and determines a prioritization plan for addressing the moisture levels and particle accumulation for vehicle 400. In this embodiment, moisture and particle management program 200 identifies multiple parking areas in a parking structure where vehicle 400 is being parked. Based on the prioritization plan, moisture and particle management program 200 identifies three parking areas for addressing three zones of vehicle 400, where the three zones include first zone 432, second zone 434, and third zone 436. First zone 432 that includes devices 406, 412, 416, and 420 located on exterior portion 402 and devices 424 and 428 located on interior portion 404. Second zone 434 that includes devices 406, 408, 410, and 414 located on exterior portion 402 and device 426 located on interior portion 404. Third zone 436 that includes devices 418 and 422 located on exterior portion 402 and devices 428 and 420 located on interior portion 404. Region 438 illustrates a zone for which moisture and particle management program 200 could not identify a parking area for vehicle 400 that can be addressed by the determined weather conditions.

Based on the prioritization plan, moisture and particle management program 200 instructs vehicle 400 to relocate to a first parking area from the multiple parking areas to address moisture levels and/or particle accumulation in first zone 432 of vehicle 400. Subsequent to determining a threshold has been reached, moisture and particle management program 200 determines another item is present on the prioritization list and determines a relocation to a second parking area is possible for the vehicle. Moisture and particle management program 200 instructs vehicle 400 to relocate to the second parking area from the multiple parking areas to address moisture levels and/or particle accumulation in second zone 434 of vehicle 400. Subsequent to determining another threshold has been reached, moisture and particle management program 200 determines another item is present on the prioritization list and determines a relocation to a third parking area is possible for the vehicle. Moisture and particle management program 200 instructs vehicle 400 to relocate to the third parking area from the multiple parking areas to address moisture levels and/or particle accumulation in third zone 436 of vehicle 400.

Embodiments of the present invention can also predict an amount of moisture and particles that accumulate on different zones and various components of a vehicle. The vehicle can include various types of sensors capable of detecting moisture levels. These sensors could include but are not limited to capacitive moisture sensors that can measure moisture levels on a surface of the vehicle, temperature and humidity sensors that can provide data on the surrounding atmospheric condition, and optical sensors that can detect water droplets and/or wet surfaces by measuring changes in light reflection and/or absorption. Moisture and particle management program 200 can also receive data from various service centers on moisture related wear and damage on different parts of the vehicle. Moisture and particle management program 200 can continuously collect data from these sensors on the vehicle during various conditions and activities, such as, washing, traveling on salt covered roads, and exposure to atmospheric moisture. Based on historically captured data related to moisture accumulation, moisture and particle management program 200 can identify both surface moisture and atmospheric conditions. Based on the sensor data, moisture and particle management program 200 can estimate an amount of moisture accumulated on different zones (exterior and/or interior) of the vehicle.

Moisture and particle management program 200 can utilize the service center data to identify the zones of the vehicle where moisture is known to accumulate, resulting in potential wear and damage due to corrosion. Based on the captured data, moisture and particle management program 200 can analyze the collected data and identify patterns related to moisture accumulation. Moisture and particle management program 200 can train machine learning models to predict moisture accumulation based on historical data and various input parameters, such as, driving conditions, vehicle based activities, environmental factors, and service center data related to moisture related wear and damage. Based on weather conditions, like atmospheric moisture and humidity levels, moisture and particle management program 200 can estimate how much moisture has accumulated on different zones of the vehicle.

Embodiments of the present invention can identify parking areas (i.e., parking spaces) and determine an amount of sunlight available on the identified parking areas over a selected time period. Moisture and particle management program 200 can identify available parking areas and assess an amount of sunlight available over time based on historical learning that considers various factors like weather data, sunlight intensity, duration of availability, and/or presence of shade. Moisture and particle management program 200 can utilize cameras and/or one or more sensors installed around the parking location to capture real-time data on available parking areas and environmental conditions. Moisture and particle management program 200 can further utilize photo detection sensors to measure sunlight intensity in different areas of the parking location. To avoid over exposure of the sun, moisture and particle management program 200 can relocate a vehicle to ensure that moisture is reduce by occupying a parking area for a specific duration of time or until a moisture level threshold is reached.

Moisture and particle management program 200 can utilize predicted weather data for atmospheric conditions such as cloud cover, precipitation, and temperature, to calculate heat generation on different portions of the parking location with the various parking areas. Moisture and particle management program 200 can process one or more camera feeds from the vehicle to detect and analyze parking area to identify the presence of shade or obstacles that may affect sunlight availability. Moisture and particle management program 200 can develop models that predict sunlight availability over time based on historical weather data, location, time of day, and seasonal variations from multiple vehicles. Based on the historically captured data and weather prediction, moisture and particle management program 200 can classify the parking area based on sunlight exposure and how much heat will be available on different portions of the parking lot. Based on the estimated and predicted sunlight intensity, moisture and particle management program 200 can predict how much sunlight heat will be available at a parking area, along with an amount of heat generated at the parking area.

Embodiments of the present invention can identify a specification of a vehicle’s internal and external components, along with a maximum amount of sunlight those internal and external components can be exposed to. Based on the service center data related to vehicle interior wear and damage, moisture and particle management program 200 can identify which of the wear and damage is related due to overexpose to sunlight. Based on the manufacturer specified details, moisture and particle management program 200 can identify how much heat is within a tolerance limit when determining whether a threshold level is reached for the exposure to sunlight. Based on the interior space of the vehicle, moisture and particle management program 200 can identify the heat generation inside the vehicle.

Embodiments of the present invention can identify how much battery power is required for the vehicle to remove the accumulated moisture and can perform an action of activating one or more systems of the vehicle for a set period of time. Based on the sensor data, moisture and particle management program 200 can estimate how much moisture is accumulated on different zones of the vehicle’s interior and/or exterior and predict an amount of moisture accumulated. Based on the amount of moisture accumulated on different zones of the vehicle’s interior and/or exterior, moisture and particle management program 200 can estimate how much heat is required to evaporate the accumulated moisture. Moisture and particle management program 200 can identify how much heat is required for different zones of the vehicle to evaporate the accumulated water and activate one or more systems (e.g., air conditioning compressor, climate control fan) to evaporate the accumulated water for a set time period based on the available battery power.

Embodiments of the present invention can also identify how much battery power is required to relocate a vehicle to another parking area and can perform an action of activating one or more system of the vehicle to relocate the vehicle to another parking area. Moisture and particle management program 200 can identify a distance between a current location and an available parking area and can calculate the battery power required to travel between the current location and the available parking area. Moisture and particle management program 200 can determine an available battery power for the vehicle and determine if the available battery power is above a threshold to allow for the vehicle to relocate between the current location and the available parking area. The threshold can be user defined to ensure a SoC of the vehicle does not fall below a certain level (e.g., 25%) or a remaining range of the vehicle does not fall below a certain level (e.g., 50 miles).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
determining, utilizing one or more sensors on a vehicle, a first moisture level for a first zone of the vehicle;
identifying a first weather condition to address the first moisture level for the first zone of the vehicle; and
performing, by one or more systems on the vehicle, a first action based on the first moisture level for the first zone of the vehicle and the first weather condition, wherein the first action includes relocating the vehicle to a parking area with the first weather condition.

2. The method of claim 1, further comprising:
determining, utilizing the one or more sensors on the vehicle, a second moisture level for a second zone of the vehicle;
identifying a second weather condition to address the second moisture level for the second zone of the vehicle; and
determining a prioritization plan to address the first moisture level and the second moisture level.

3. The method of claim 2, wherein performing the first action based on the first moisture level for the first zone of the vehicle and the first weather condition is further based on the prioritization plan.

4. The method of claim 3, further comprising:
performing, by the one or more systems on the vehicle, a second action based on the second moisture level for the second zone of the vehicle, the second weather condition, and the prioritization plan, wherein the second action includes activating a climate control system on the vehicle.

5. The method of claim 1, further comprising:
determining particle accumulation on a second zone of the vehicle;
identifying a second weather condition to address the particle accumulation for the second zone of the vehicle; and
determining a prioritization plan to address the first moisture level and the particle accumulation.

6. The method of claim 5, wherein performing the first action based on the first moisture level for the first zone of the vehicle and the first weather condition is further based on the prioritization plan.

7. The method of claim 6, further comprising:
performing, by the one or more systems on the vehicle, a second action based on the particle accumulation for the second zone of the vehicle, the second weather condition, and the prioritization plan, wherein the second action includes relocating the vehicle to another parking area with the second weather condition.

8. A computer program product comprising:
one or more computer readable storage media;
program instructions stored on at least one of the one or more computer readable storage media to perform operations comprising:
determining, utilizing one or more sensors on a vehicle, a first moisture level for a first zone of the vehicle;
identifying a first weather condition to address the first moisture level for the first zone of the vehicle; and
performing, by one or more systems on the vehicle, a first action based on the first moisture level for the first zone of the vehicle and the first weather condition, wherein the first action includes relocating the vehicle to a parking area with the first weather condition.

9. The computer program product of claim 8, wherein the operations further comprise:
determining, utilizing the one or more sensors on the vehicle, a second moisture level for a second zone of the vehicle;
identifying a second weather condition to address the second moisture level for the second zone of the vehicle; and
determining a prioritization plan to address the first moisture level and the second moisture level.

10. The computer program product of claim 9, wherein performing the first action based on the first moisture level for the first zone of the vehicle and the first weather condition is further based on the prioritization plan.

11. The computer program product of claim 10, wherein the operations further comprise:
performing, by the one or more systems on the vehicle, a second action based on the second moisture level for the second zone of the vehicle, the second weather condition, and the prioritization plan, wherein the second action includes activating a climate control system on the vehicle.

12. The computer program product of claim 8, wherein the operations further comprise:
determining particle accumulation on a second zone of the vehicle;
identifying a second weather condition to address the particle accumulation for the second zone of the vehicle; and
determining a prioritization plan to address the first moisture level and the particle accumulation.

13. The computer program product of claim 12, wherein performing the first action based on the first moisture level for the first zone of the vehicle and the first weather condition is further based on the prioritization plan.

14. The computer program product of claim 13, wherein the operations further comprise:
performing, by the one or more systems on the vehicle, a second action based on the particle accumulation for the second zone of the vehicle, the second weather condition, and the prioritization plan, wherein the second action includes relocating the vehicle to another parking area with the second weather condition.

15. A computer system comprising:
a processor set;
one or more computer readable storage media;
program instructions stored on the one or more computer readable storage media to cause the processor set to perform operations comprising:
determining, utilizing one or more sensors on a vehicle, a first moisture level for a first zone of the vehicle;
identifying a first weather condition to address the first moisture level for the first zone of the vehicle; and
performing, by one or more systems on the vehicle, a first action based on the first moisture level for the first zone of the vehicle and the first weather condition, wherein the first action includes relocating the vehicle to a parking area with the first weather condition.

16. The computer system of claim 15, wherein the operations further comprise:
determining, utilizing the one or more sensors on the vehicle, a second moisture level for a second zone of the vehicle;
identifying a second weather condition to address the second moisture level for the second zone of the vehicle; and
determining a prioritization plan to address the first moisture level and the second moisture level.

17. The computer system of claim 16, wherein performing the first action based on the first moisture level for the first zone of the vehicle and the first weather condition is further based on the prioritization plan.

18. The computer system of claim 17, wherein the operations further comprise:
performing, by the one or more systems on the vehicle, a second action based on the second moisture level for the second zone of the vehicle, the second weather condition, and the prioritization plan, wherein the second action includes activating a climate control system on the vehicle.

19. The computer system of claim 15, wherein the operations further comprise:
determining particle accumulation on a second zone of the vehicle;
identifying a second weather condition to address the particle accumulation for the second zone of the vehicle; and
determining a prioritization plan to address the first moisture level and the particle accumulation,
wherein performing the first action based on the first moisture level for the first zone of the vehicle and the first weather condition is further based on the prioritization plan.

20. The computer system of claim 19, wherein the operations further comprise:
performing, by the one or more systems on the vehicle, a second action based on the particle accumulation for the second zone of the vehicle, the second weather condition, and the prioritization plan, wherein the second action includes relocating the vehicle to another parking area with the second weather condition.
